(19) United States
(12) Patent Application Publication
(10) Pub. No.: US 2026/0119962 A1
(43) Pub. Date: Apr. 30, 2026

(54) Active Learning for Few-Shot Learning

(71) Applicant: SRI International, Menio Park, CA (US)

(72) Inventors: Xiao LIN, Union City, CA (US); Yi YAO, Princeton, NJ (US); Meng YE, Pennington, NJ (US); Yunye GONG, West Windsor, NJ (US); Giedrius Tomas BURACHAS, Redwood City, CA (US); Nikoletta BASIOU, Redwood City, CA (US); Ajay DIVAKARAN, Monmouth Junction, NJ (US)

(21) Appl. No.: 18/913,873

(22) Filed: Oct. 11, 2024

Related U.S. Application Data
(60) Provisional application No. 63/591,901, filed on Oct. 20, 2023.

(30) Foreign Application Priority Data
Oct. 13, 2023 (GR) 20230100849

(51) Int. Cl. G06N 20/00; G06V 10/774; G06V 20/70

(52) U.S. Cl. CPC G06N 20/00; G06V 10/7753; G06V 20/70

(57) ABSTRACT

A method and apparatus for adapting a pretrained machine learning model using active learning for improved task performance in a target domain includes embedding a vector representation of at least one unlabeled target class data in an embedding space associated with the pretrained machine learning model, analyzing the embedding space to select, for labeling, at least one unlabeled class data representation based on a distance measurement in the embedding space that identifies an unlabeled class data representation that, if labeled, improves a coverage for at least one unlabeled target class data representation in the embedding space, labeling the selected at least one unlabeled class data representation, and adapting the pretrained machine learning model for improved task performance in a domain of the at least one unlabeled target class data for which coverage was improved by retraining the pretrained machine learning model using the labeled unlabeled class data representation.

### CROSS-REFERENCE TO RELATED APPLICATIONS

This application claims benefit of and priority to U.S. Provisional Patent Application Ser. No. 63/591,901, filed Oct. 20, 2023 and Greek patent application No. 20230100849, filed Oct. 13, 2023, which are both herein incorporated by reference in their entireties.

### GOVERNMENT RIGHTS

This invention was made with Government support under contract number FA8750-19-C-0511 awarded by the Air Force Research Projects Laboratory. The Government has certain rights in this invention.

### FIELD OF THE INVENTION

Embodiments of the present principles generally relate to active learning as applied to machine learning and, more particularly, to a method, apparatus and system for adapting a pretrained machine learning model/classifier to learn a task for which the machine learning model/classifier was not previously trained using novel active learning techniques.

### BACKGROUND

Machine learning models can perform tasks for which they were trained. For example, image classifiers/classification models include machine learning models that analyze images and assign the images a category label. Similarly, object detectors including machine learning models that can identify objects in images. Image classifiers/classification models and object detectors are part of the field of computer vision and are used in many industries. Recent advances in computer vision technology have implemented active learning techniques in machine learning models for training. The goal of active learning is to adaptively select unlabeled samples for annotations to maximize the performance gain per label query. Current active learning techniques in machine learning models can use prediction probability or information gain estimations as a score to select samples.

In active learning techniques using prediction probability, if the maximum predicted probability is high, it is assumed that the model has learned the information in the sample and does not need to be added to the labeled datasets. In active learning techniques using information gain estimations an evaluation metric is calculated by subtracting the weighted entropies of each branch from the original entropy.

However, such active learning techniques require a subject machine learning model to be thoroughly trained using a plurality of training data to provide accurate probability predictions and information gain estimations and are not well suited for tasks for which the machine learning model was not specifically trained or for few-shot active learning as weakly trained models cannot provide accurate probability predictions and information gain estimations.

As such, what is needed is a technical solution to the technical problem of how to adapt a machine learning model for targeted tasks for which the model was not trained and/or for few-shot learning.

### SUMMARY

Embodiments of the present principles provide a method, apparatus, and system for adapting a pretrained machine learning model/classifier for, for example, targeted tasks and/or few-shot learning using novel active learning techniques.

In some embodiments, a method for adapting a pretrained machine learning model using active learning for improved task performance in a target domain in which the pretrained model was not originally trained includes embedding or projecting a vector representation of at least one unlabeled target class data in an embedding space associated with the pretrained machine learning model, the embeddings space including embedded, respective vector representations of labeled class data and unlabeled class data, analyzing the embedding space to select, for labeling, at least one unlabeled class data representation based on a distance measurement in the embedding space that identifies an unlabeled class data representation that, if labeled, improves a coverage for at least one unlabeled target class data representation in the embedding space, labeling the selected at least one unlabeled class data representation, and adapting the pretrained machine learning model for improved task performance in a domain of the at least one unlabeled target class data for which coverage was improved by retraining the pretrained machine.

In some embodiments, an apparatus for adapting a pretrained machine learning model using active learning for improved task performance in a target domain in which the pretrained model was not originally trained includes a processor and a memory accessible to the processor. In such embodiments, the memory has stored therein at least one of programs or instructions which when executed by the processor configures the apparatus to embed or project a vector representation of at least one unlabeled target class data in an embedding space associated with the pretrained machine learning model, the embeddings space including embedded, respective vector representations of labeled class data and unlabeled class data, analyze the embedding space to select, for labeling, at least one unlabeled class data representation based on a distance measurement in the embedding space that identifies an unlabeled class data representation that, if labeled, improves a coverage for at least one unlabeled target class data representation in the embedding space, label the selected at least one unlabeled class data representation, and adapt the pretrained machine learning model for improved task performance in a domain of the at least one unlabeled target class data for which coverage was improved by retraining the pretrained machine learning model using the labeled at least one unlabeled class data representation.

In some embodiments, a non-transitory computer readable storage medium has stored thereon instructions that when executed by a processor perform a method for adapting a pretrained machine learning model using active learning for improved task performance in a target domain in which the pretrained model was not originally trained. In some embodiments, the method includes embedding or projecting a vector representation of at least one unlabeled target class data in an embedding space associated with the pretrained machine learning model, the embeddings space including embedded, respective vector representations of labeled class data and unlabeled class data, analyzing the embedding space to select, for labeling, at least one unlabeled class data representation based on a distance measurement in the embedding space that identifies an unlabeled class data representation that, if labeled, improves a coverage for at least one unlabeled target class data representation in the embedding space, labeling the selected at least one unlabeled class data representation, and adapting the pretrained machine learning model for improved task performance in a domain of the at least one unlabeled target class data for which coverage was improved by retraining the pretrained machine learning model using the labeled at least one unlabeled class data representation.

Other and further embodiments in accordance with the present principles are described below.

### BRIEF DESCRIPTION OF THE DRAWINGS

So that the manner in which the above recited features of the present principles can be understood in detail, a more particular description of the principles, briefly summarized above, may be had by reference to embodiments, some of which are illustrated in the appended drawings. It is to be noted, however, that the appended drawings illustrate only typical embodiments in accordance with the present principles and are therefore not to be considered limiting of its scope, for the principles may admit to other equally effective embodiments.

FIG. 1 depicts a high-level block diagram of an active learning training system in accordance with at least one embodiment of the present principles.

FIG. 2 depicts a graphical representation of a functionality of a distance-entropy active learning technique of the present principles in accordance with at least one embodiment.

FIG. 3 depicts a graphical representation of a functionality of a distance-goal active learning technique of the present principles in accordance with at least one embodiment.

FIG. 4 depicts a flow diagram of a method for adapting a pretrained machine learning model for active learning in accordance with an embodiment of the present principles.

FIG. 5 depicts a table listing classification accuracy on the DomainNet-Heal dataset using different active learning/labeling techniques including random query, entropy-based, and the distance-based techniques of the present principles.

FIG. 6A depicts depict results of an active learning training system of the present principles, such as the active learning training system of FIG. 1, on a DomainNet-Clipart dataset.

FIG. 6B depicts depict results of an active learning training system of the present principles, such as the active learning training system of FIG. 1, on a CIFAR-100 dataset.

FIG. 6C depicts depict results of an active learning training system of the present principles, such as the active learning training system of FIG. 1, on a CUB dataset.

FIG. 7 depicts a high-level block diagram of a computing device suitable for use with an active learning training system in accordance with at least one embodiment of the present principles.

FIG. 8 depicts a high-level block diagram of a network in which embodiments of an active learning training system in accordance with the present principles can be applied.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present principles generally relate to methods, apparatuses and systems for adapting a pretrained machine learning model/classifier for, for example, targeted tasks and/or for few-shot learning using novel active learning techniques. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims. For example, although embodiments of the present principles will be described primarily with respect to a specific embedding space and specific distance measurement techniques with regards to image classification, embodiments of the present principles can be implemented with substantially any embedding space using substantially any distance measurement techniques for adapting a machine learning model to perform targeted tasks.

In the description herein, the phrase “class data” and the like is intended to describe data associated with the performance of a portion of a task, an entire task, or a group of related tasks that share a common category. As such, when class data is referenced herein, the class data can be referring data associated with the performance of a portion of a task, an entire task, or a group of related tasks that share a common category.

Embodiments of the present principles provide, at least, a technical solution to the technical problem of how to adapt a machine learning model for targeted tasks for which the model was not trained by providing a method, apparatus and system including novel active leaning techniques which adapt a pretrained machine learning model using active learning for improved task performance in a target domain in which the pretrained model was not originally trained at least as described herein.

In some embodiments, novel active learning techniques of the present principles are based on distance measures between vectors in an embedding space. Such active learning techniques of the present principles can be applied to a pre-trained machine learning model, such as an image classifier/classification model, to adapt the pre-trained machine learning model for improved learning to enable the machine learning model to perform targeted tasks for which the machine learning model was not specifically pretrained, for example, image classification, object detection, and/or few-shot learning. For example, embodiments of the present principles can be implemented using two active learning approaches, distance-entropy and distance-goal, that are based on distance measurements between vectors in an embedding space. For both approaches, a two-stage training paradigm, namely pre-training and adaptation, can be adopted for adapting a pre-trained machine learning model, such as an image classifier/classification model or an object detection model, to better detect images and/or objects in a specific class, or in addition, in some embodiments for few-shot learning. In such embodiments of the present principles, a pre-trained embedding space is well defined and, as such, the distance between vectors in such an embedding space becomes a more robust metric.

For embodiments of a distance-entropy active learning technique of the present principles, a vector representation of unlabeled class data, such as in some embodiments an unlabeled/unclassified image embedded in an embedding space, that is equidistant from a number of selected vector representations of respective labeled class data, such as in some embodiments classified images embedded in the embedding space, can be selected for classification.

For embodiments of a distance-goal active learning technique of the present principles, a vector representation of at least one unlabeled target class data, such as test/query samples, can be embedded in an embedding space associated with a pretrained machine learning model. An unlabeled class data representation embedded in an embedding space that, if classified, would provide better classification amongst selected unlabeled target class data representations, such as unlabeled test samples, can be selected for classification. In accordance with the present principles, the labeling/classification of the selected unlabeled/unclassified class data embedded in the embedding space improves the performance of a task associated with target data representations for an associated, pretrained machine learning, for which the machine learning model was not previously trained. For example, in some embodiments, the labeling/classification of the selected unlabeled/unclassified image representations in the embedding space improves a gain per label query associated with the embedding space, which enables few-shot learning. Embodiments of the novel active learning techniques of the present principles are described in greater detail below.

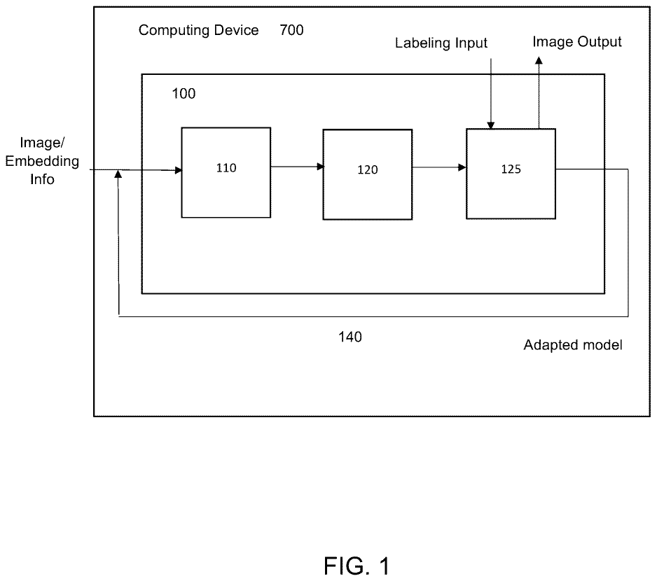

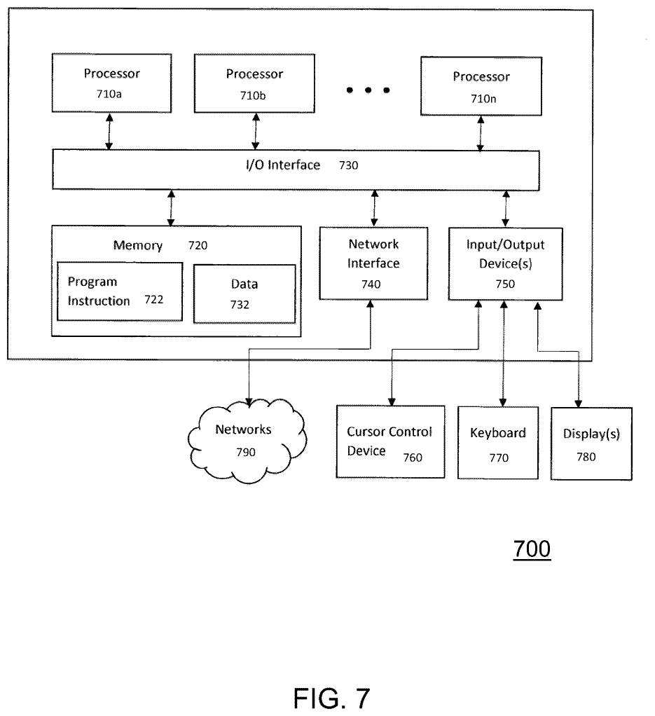

FIG. 1 depicts a high-level block diagram of an active learning training system 100 in accordance with at least one embodiment of the present principles. The active learning training system 100 of FIG. 1 illustratively comprises an embedding module 110, a distance measurement module 120 and a labeling module 125. As depicted in the embodiment of FIG. 1, the active learning training system 100 of FIG. 1 can receive data from at least a pretrained classification model 130 and a human and in some embodiments, a feedback 140 from the system 100 itself. As further depicted in FIG. 1, embodiments of an active learning training system of the present principles, such as the active learning training system 100 of FIG. 1, can be implemented via a computing device 700 (described in greater detail below with respect to FIG. 7) in accordance with the present principles.

An active learning training system of the present principles, such as the active learning training system 100 of FIG. 1, enables the adaptation of an embedding space of, for example, a pre-trained machine learning model for adapting the pretrained machine learning model using active learning for improved task performance in a target domain in which the pretrained model was not originally trained, by implementing novel active learning techniques, such as a distance-entropy active learning technique and/or a distance-goal active learning technique.

Alternatively or in addition, in some embodiments in which an embedding space is not predetermined (i.e., is not communicated to the active learning training system of the present principle from a machine learning model), the embedding module 110 of the active learning training system 100 of FIG. 1, can receive labeled images, unlabeled images and unlabeled test images of interest (i.e., to be evaluated) and can generate vector representations of the labeled images, unlabeled images and unlabeled test images and embed such vector representations into a common embedding space for further analysis and evaluation by, for example, the distance measurement module 120 in accordance with the present principles.

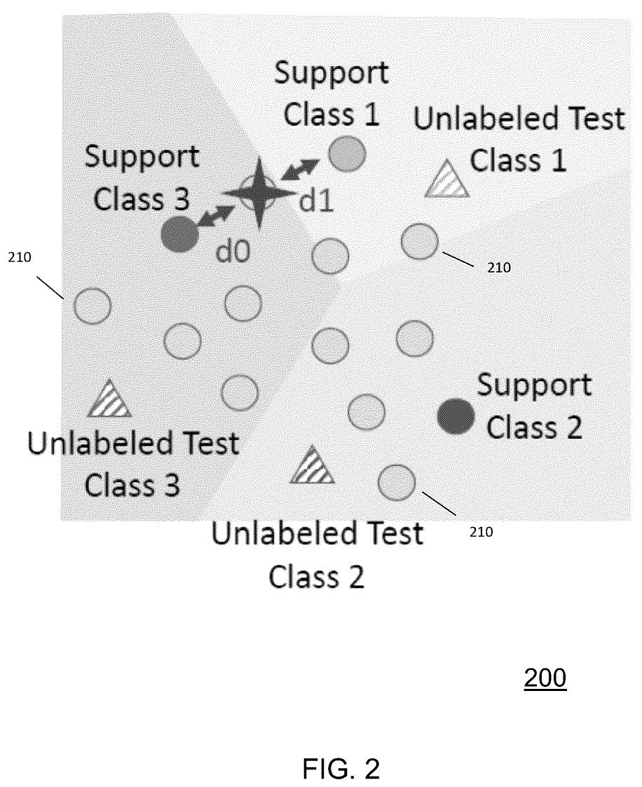

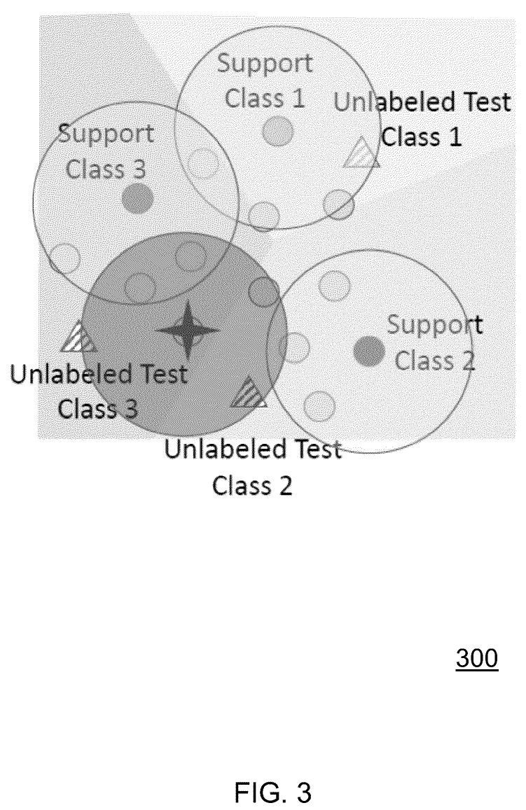

FIG. 2 depicts a graphical representation of a functionality of a distance-entropy active learning technique of an active learning training system of the present principles in accordance with at least one embodiment. Although the embodiment of FIG. 2 is described with reference to a pretrained image classifier model for which embodiments of the present principles improve the ability to classify images in a target domain, in alternate embodiments, the functionality of the present principles can be applied for improving the ability of a machine learning system to perform other tasks, including but not limited to object detection. More specifically, FIG. 2 depicts a common embedding space 200 of, for example, a pre-trained image classifier/classification model or an embedding space determined by an active learning training system of the present principles including a plurality of embedded image vectors. In the embodiment of FIG. 2, the embedding space 200 illustratively comprises three (3) embedded vectors of labeled images identified as support class 1, support class 2, support class 3 and depicted as darkened circles. The embedding space 200 of FIG. 2 further illustratively comprises a plurality of embedded vectors of unlabeled images (a few labeled 210 for illustrative purposed) depicted as lighter circles. In addition, the embedding space 200 of FIG. 2 further illustratively comprises three (3) embedded vectors of unlabeled test images identified in FIG. 2 as unlabeled test class 1, unlabeled test class 2, and unlabeled test class 3 and depicted as respective triangles. The test class vectors depicted in FIG. 2 are described in further detail with respect to FIG. 3.

With reference to the embedding space 200 in FIG. 2, an objective of an active learning training system of the present principles, such as the active learning training system 100 of FIG. 1, is to determine which unlabeled image in the embedding space, if classified, would provide an advantageous gain per label query. For example, in some embodiments, an objective of an active learning training system of the present principles is to identify/select at least one vector representation of an unlabeled image/sample for annotation, to improve the performance gain per label query in the embedding space 200. Once at least one selected vector representation of an unlabeled image is annotated (e.g., labeled with a class), the embedding space (e.g., image classifier/classification model) can be retrained using the newly labeled images.

In accordance with the present principles, the distance measurement module 120 of the active learning training system 100 of FIG. 1, in applying a distance-entropy active learning technique of the present principles, identifies at least one vector representation of the unlabeled images that is located in the embedding space between at least two vector representations of labeled images having different classes. That is, the distance measurement module 120 can determine a distance between vector representations of unlabeled images and vector representations of the at least two labeled images. The distance measurement module 120 then selects a vector representation of an unlabeled image that measures a shortest distance from (is closest to) the vector representations of the at least two labeled image as an unlabeled image vector that should be labeled. In some embodiments implementing a distance-entropy active learning technique of the present principles, a distance can be measured by the distance measurement module 120 according to equation one (1), which follows:

$$s ( x ) = \vert \{ v ( x ) , v ( {x}_{0}^{support} ) \} - \{ v ( x ) , v ( {x}_{1}^{support} ) \} \vert . \qquad ( 1 )$$

For example and with reference to the embedding space 200 of FIG. 2, the distance measurement module 120 identifies vector representations of unlabeled images (lighter circles) that are located between the vector representations of the two labeled images, support class 1 and support class 3. In the embedding space 200 of FIG. 2, the distance measurement module 120 selects the vector representation of the unlabeled image marked with a cross as having a shortest distance from (is closest to) the vector representations of the two labeled images, support class 1 and support class 3. In the embodiment of FIG. 2, the vector representation of the unlabeled image marked with a cross is selected by the measurement module 120 for classification (e.g., labeling).

In some embodiments of the present principles, the labeling module 125 can cause a selected unlabeled image to be classified/labeled. For example, in some embodiments of the present principles, the labeling module 125 can cause a visual representation of the selected unlabeled image to be presented to a user of an active learning training system of the present principles, such as the active learning training system 100 of FIG. 1, on for example a display of the computing device 700, and can enable the user/human to classify/label the selected unlabeled image using, for example, an input device of the computing device 700.

Alternatively or in addition, in some embodiments, a labeling module of the present principles, such as the labeling module 125 of FIG. 1 can include a machine learning model/system 127. In some embodiments, the machine learning model/system 127 can include a multi-layer neural network comprising nodes that are trained to have specific weights and biases and can employ artificial intelligence techniques or machine learning techniques to analyze received data images including unlabeled images selected by, for example, the distance measurement module 120.

In some embodiments in accordance with the present principles, to label selected, unlabeled images, the machine learning model/system 127 can implement suitable machine learning techniques to learn commonalities in sequential application programs and for determining from the machine learning techniques at what level sequential application programs can be canonicalized. In some embodiments, machine learning techniques that can be applied to learn commonalities in sequential application programs can include, but are not limited to, regression methods, ensemble methods, or neural networks and deep learning such as ‘Seq2Seq’ Recurrent Neural Network (RNNs)/Long Short-Term Memory (LSTM) networks, Convolution Neural Networks (CNNs), graph neural networks applied to the abstract syntax trees corresponding to the sequential program application, Transformer networks, and the like. In some embodiments a supervised machine learning (ML) classifier/algorithm could be used such as, but not limited to, Multilayer Perceptron, Random Forest, Naive Bayes, Support Vector Machine, Logistic Regression and the like. In addition, in some embodiments, the ML classifier/algorithm of the present principles can implement at least one of a sliding window or sequence-based techniques to analyze data.

A machine learning model/system of the present principles, such as the machine learning model/system 127 of the labeling module 125 of the, active learning training system 100 of FIG. 1, can be trained using a plurality (e.g., hundreds, thousands, millions, etc.) of instances of labeled image data in which the training data comprises a plurality of labeled images and respective features of the images to train a machine learning model/system of the present principles to label received unlabeled images and to classify the portions into categories/classes.

Although in the embodiment of FIG. 2 a distance measure is determined for vector representations of unlabeled images between two labeled image classes, alternatively or in addition, in some embodiments, distance measures in accordance with the present principles can be determined for vector representations of unlabeled images between more than two labeled image classes, such as with reference to FIG. 2, support class 1, support class 2, support class 3. In such an embodiment, a vector representation of an unlabeled image that has a distance measure that is a shortest distance from (closest to) all three labeled image classes is selected for classification/labeling in accordance with the present principles.

FIG. 3 depicts a graphical representation of a functionality of a distance-goal active learning technique of the present principles in accordance with at least one embodiment. Although the embodiment of FIG. 3 is described with reference to a pretrained image classifier model for which embodiments of the present principles improve the ability to classify images in a target domain, in alternate embodiments, the functionality of the present principles can be applied for improving the ability of a machine learning system to perform other tasks, including but not limited to object detection. More specifically, FIG. 3 depicts the same common embedding space 200 of FIG. 2, in which an alternate active learning technique of the present principles has been applied. In the embodiment of FIG. 3, an embedding module of the present principles, such as the embedding module 110 of the active learning training system 100 of FIG. 1, can embed or project a vector representation of at least one unlabeled target class data in the embedding space 200 associated with a pretrained machine learning model. Specifically, in the embodiment of FIG. 3, the embedding module 110 embeds or projects test images, unlabeled test class 1, unlabeled test class 2, and unlabeled test class 3, into the embedding space 200. In accordance with the present principles, the test images embedded or projected into the embedding space are implemented to adapt a pretrained machine learning model associated with the embedding space 200 to perform targeted tasks related to the test images (described in greater detail below). Although in the embodiment of FIG. 3, it is described that the embedding module 110 of the active learning training system 100 of FIG. 1 can embed or project a vector representation of at least one unlabeled target class data in the embedding space 200, alternatively or in addition, in some embodiments, unlabeled target data representations, such as test images, unlabeled test class 1, unlabeled test class 2, and unlabeled test class 3, exist in the embedding space 200 from other sources, such as because a query request including the unlabeled target data was received by, for example, the machine learning model.

In the embodiment of FIG. 3, the distance measurement module 120 of the active learning training system 100 of FIG. 1, in applying a distance-goal active learning technique of the present principles, identifies image vector representations of unlabeled images in an embedding space that are located in the embedding space in positions that provide coverage/cover (provide class/category information for) for unlabeled test examples/images. That is, in some embodiments of the present principles, sample labeled images used to train an embedding space of, for example, an image classifier/classification model, can be captured with different parameters than query/test images making classification of the query/test images difficult. For example, during training of, for example, an image classifier/classification model, sample, labeled images can be captured using a high resolution capture device/camera. Subsequently, during testing or query, images can be captured using a low resolution capture device/camera. In such embodiments, vector representations of unlabeled test images can be projected/embedded into the embedding space, such as the embedding space 200 of FIG. 3, illustratively as unlabeled test class 1, unlabeled test class 2, and unlabeled test class 3, depicted as respective triangles. In accordance with the present principles, a vector representation of an unlabeled test class is projected/embedded into an embedding space, such as the embedding space 200 of FIG. 3, to enable an active learning training system of the present principles, such as the active learning training system 100 of FIG. 1, to focus an active learning of, for example, an image classifier/classification model associated with the embedding space, to a domain (area) of a test image of interest in the embedding space and thus improving the learning of, for example, the image classifier/classification model associated with the embedding space in at least the domain (area) of the test image of interest, which, for example, enables the ability of the image classifier/classification model to perform few-shot learning.

More specifically, in some embodiments of the present principles, the distance measurement module 120 of the active learning training system 100 of FIG. 1, in applying a distance-goal active learning technique of the present principles, determines a vector representation of an unlabeled image in the embedding space that, if labeled, would improve a coverage of at least one unlabeled test class in an embedding space. In the embodiment of FIG. 3, the distance measurement model 120 can determine a coverage area of each of the vector representations of the labeled images, support class 1, support class 2, support class 3. In the embodiment of FIG. 3, the coverage areas of the labeled images are identified as larger circles. Although in the embodiment of FIG. 3, the larger coverage circles identify a specific coverage area, in alternate embodiments of the present principles, each embedded labeled image can comprise a different coverage area in the embedding space, which can be based on at least one of or a combination of number of labeled images in the embedding space, a number of unlabeled test images (examples) in the embedding space, and/or a number of unlabeled images in the embedding space. For example, in an embodiment in which an embedding space has many embedded labeled images, a coverage area of each labeled image can be smaller and still cover (provide class/category information for) the unlabeled test images in the embedding space. In some embodiments of the present principles, a determined coverage area of a labeled image embedded in the embedding space can be based on a granularity desired.

Referring back to the embedding space 200 of FIG. 3, from the determined coverages of the embedded vector representations of the labeled images, the distance measurement module 120 of the active learning training system 100 of FIG. 1, can determine an area in the embedding space in which unlabeled test images (examples) have less coverage (illustratively depicted in FIG. 3 as a larger darker circle of the same coverage size as the coverage of the labeled images). In the embodiment of FIG. 3, the distance measurement module 120 of the active learning training system 100 of FIG. 1 can determine a vector representation of an unlabeled image in the embedding space in the area of less coverage (e.g., the larger darker circle) that if labeled would improve the coverage (provide class/category information for) at least one unlabeled test image in the embedding space.

For example, in the embodiment of FIG. 3, the distance measurement module 120 of the active learning training system 100 of FIG. 1, in applying a distance-goal active learning technique of the present principles, selects the vector representation of the unlabeled image marked with a cross as providing a best coverage for at least the vector representations of the two unlabeled test images, unlabeled test class 1 and unlabeled test class 3, which exist in an uncovered area of the embedding space 200. As such, in the embodiment of FIG. 3, the vector representation of the unlabeled image marked with a cross is selected by the measurement module 120 for classification (e.g., labeling).

In embodiments of the present principles, a vector representation of an unlabeled image in the embedding space is selected for classification based on distance measurements in the embedding space. For example, in some embodiments, distances between vector representations of unlabeled images (represented by light, smaller circles) within the area of determined reduced coverage (larger darker circle in FIG. 3) and vector representations of at least one unlabeled test image (example) are measured and a vector representation of an unlabeled image which has a distance measure most beneficial to (closest on average to; provides most improved coverage for) the at least one unlabeled test image (example) is selected for labeling. Although in the embodiment of FIG. 3, a coverage area for labeled images and an area of reduced coverage near embedded/projected unlabeled test images (examples) is determined by the distance measurement module 120 to determined which unlabeled images within the reduced coverage area should be measured for possible labeling, in alternate embodiments of the present principles, coverage areas and reduced coverage areas are not determined and all unlabeled images embedded in an embedding space can be evaluated in accordance with the present principles (i.e., based on distance measurements in the embedding space) to determine at least one unlabeled image in the embedding space that, if labeled, will improve the coverage ((provide class/category information for) for at least one test image (example) in the embedding space.

For example, in some embodiments, a coverage measure can be implemented to determine at least how a selected unlabeled image in an embedding space, if labeled, will improve the coverage of at least one unlabeled test image (example) in the embedding space. In some embodiments, the coverage measure of the present principles of how well a training set

$$\{ {x}_{i}^{train} \}$$

covers test set

$$\{ {x}_{j}^{test} \}$$

can be determined according to equation two (2), which follows:

$$Coverage ( \{ {x}_{i}^{t r a i n} \} , \{ {x}_{j}^{t e s t} \} ) = {\sum }_{\{ {x}_{j}^{t e s t} \}} log {\sum }_{\{ {x}_{i}^{train} \}} {e}^{\frac{< v ( {x}_{t}^{train} ) , v ( {x}_{j}^{t e s t} ) >}{T}} , in which \{ {x}_{i}^{train} \} \qquad ( 2 )$$

depicts a set of current training examples, already selected and labeled, i depicts the i-th example,

$$\{ {x}_{j}^{test} \}$$

depicts a set of unlabeled test examples from the target domain, {xₖ} depicts a set of unlabeled examples that active learning is selecting from, v(·) depicts the embedding function, and <·,·> depicts the similarity function. In some embodiments of the present principles, a cosine similarity:

$$< a , b > = \frac{a \cdot b}{‖ a ‖ ‖ b ‖}$$

is implemented for the distance measurements. Alternatively or in addition, in some embodiments, an inverse of Euclidean distance can also be used: <a, b>=−∥a−b∥₂.

The coverage measure of the present principles evaluates, for every unlabeled test example from the target domain

$${x}_{i}^{t e s t} ,$$

what is the maximum embedding similarity across all training examples (or from a distance point of view, minimum distance). The log-sum-exp structure implements a soft maximum over similarities.

In some embodiments of the present principles, a temperature parameter T can be used to control how “soft” the maximum is. For small T, high similarity examples will contribute exponentially more. For large T, high similarity examples will contribute linearly proportional to the similarity value. Empirically, T can typically be set to 0.1 for cosine similarity.

It should be noted that certain few-shot learning algorithms, e.g. Prototypical Networks, also implement a temperature T on cosine similarity (often called scaled cosine distance s·<v₀, v₁>, in which s is equivalent to 1/T), and in few-shot learning T can be optimized through cross validation. However, in the active learning of the present principles, cross validation was not possible. However, in some embodiments, a same temperature T that's optimal in few-shot learning was implemented. In some embodiments of the preset principles, an unlabeled example xₖ that maximizes an improvement in coverage measure is selected according to the equations, which follow:

$$Improvement ( {x}_{k} , \{ {x}_{i}^{train} \} , \{ {x}_{j}^{test} \} ) = Coverage ( \{ {x}_{i}^{train} \} + {x}_{k} , \{ {x}_{j}^{test} \} ) - Coverage ( \{ {x}_{i}^{train} \} , \{ {x}_{j}^{test} \} ) = {\sum }_{\{ {x}_{j}^{t e s t} \}} log {\sum }_{\{ {x}_{i}^{t r a i n} \} + {x}_{k}} {e}^{\frac{< v ( {x}_{i}^{t r a i n} ) , v ( {x}_{j}^{t e s t} ) >}{T}} - {\sum }_{\{ {x}_{j}^{t e s t} \}} log {\sum }_{\{ {x}_{i}^{t r a i n} \}} {e}^{\frac{< v ( {x}_{i}^{t r a i n} ) , v ( {x}_{j}^{t e s t} ) >}{T}} ,$$

and merging two terms,

$$log ( x ) - log ( y ) = log ( x / y ) = {\sum }_{\{ {x}_{j}^{t e s t} \}} log \{ {\sum }_{\{ {x}_{i}^{t r a i n} \} + {x}_{k}} {e}^{\frac{< v ( {x}_{i}^{t r a i n} ) , v ( {x}_{j}^{t e s t} ) >}{T}} / {\sum }_{\{ {x}_{i}^{t r a i n} \}} {e}^{\frac{< v ( {x}_{i}^{t r a i n} ) , ν ( {x}_{j}^{t e s t} ) >}{T}} \}$$

and spelling out sum over {xtrain}+xk into two parts, one sum over xtrain and one term on xk,

$$= {\sum }_{\{ {x}_{j}^{t e s t} \}} log \{ ( 1 + {e}^{\frac{< v ( {x}_{k} ) , v ( {x}_{j}^{t e s t} ) >}{T}} / {\sum }_{\{ {x}_{i}^{t r a i n} \}} {e}^{\frac{< v ( {x}_{i}^{t r a i n} ) , v ( {x}_{j}^{t e s t} ) >}{T}} ) \}$$

and dividing both top and bottom by the sum over xtrain

$$= {\sum }_{\{ {x}_{j}^{t e s t} \}} log \{ ( 1 + {e}^{\frac{< v ( {x}_{k} ) , v ( {x}_{j}^{t e s t} ) >}{T} - log {\sum }_{\{ {x}_{i}^{t r a i n} \}} {e}^{\frac{< v ( {x}_{i}^{t r a i n} ) , ν ( {x}_{j}^{t e s t} ) >}{T}}} ) \}$$

$$where e \hat{} x / y = e \hat{} ( x - log ( y ) )$$

$$= {\sum }_{\{ {x}_{j}^{t e s t} \}} log \{ ( 1 + {e}^{\frac{< v ( {x}_{k} ) , v ( {x}_{j}^{t e s t} ) >}{T} - log {\sum }_{\{ {x}_{i}^{t r a i n} \}} {e}^{\frac{< v ( {x}_{i}^{t r a i n} ) , v ( {x}_{j}^{t e s t} ) >}{T}}} ) \}$$

$$where logsigmoid ( x ) = log 1 / ( 1 + e \hat{} - x ) , so logsigmoid ( x ) = log ( 1 + e \hat{} - x )$$

$$= \text{} - {\sum }_{\{ {x}_{j}^{t e s t} \}} logsigmoid ( - \frac{< v ( {x}_{k} ) , v ( {x}_{j}^{t e s t} ) >}{T} + log {\sum }_{\{ {x}_{i}^{t r a i n} \}} {e}^{\frac{< v ( {x}_{i}^{t r a i n} ) , v ( {x}_{j}^{t e s t} ) >}{T}} ) .$$

In some embodiments, the temperature T variable is not implemented in the calculations of the present principles, and, as such, is removed from the equations above.

In some embodiments, the active learning of the present principles can include a selection of multiple unlabeled images that maximize coverage. In such embodiments, a greedy algorithm can be used in which in each iteration (e.g. iteration t) the example

$${x}_{k}^{t}$$

with maximum improvement is selected. Then

$${x}_{k}^{t} to \{ {x}_{i}^{train} \}$$

can be added and an improvement computation can be run again and example

$${x}_{k}^{t + 1}$$

can be subsequently selected.

Referring back to the embodiment of FIG. 3, once at least one unlabeled image, which improves a coverage for at least one unlabeled test image (example) has been identified in the embedding space 200, in accordance with the present principles, the at least one identified, unlabeled test image can be selected for labeling. That is, in some embodiments and as described above with the embodiment of FIG. 2, the labeling module 125 can cause a selected unlabeled image to be classified/labeled. For example, in some embodiments of the present principles, the labeling module 125 can cause a visual representation of the selected unlabeled image to be presented to a user of an active learning training system of the present principles, such as the active learning training system 100 of FIG. 1, on for example a display of the computing device 700, and can enable the user/human to classify/label the selected unlabeled image using, for example, an input device of the computing device 700. Alternatively or in addition, in some embodiments, a labeling module of the present principles, such as the labeling module 125 of FIG. 1 can cause the selected unlabeled image to be classified/labeled using the machine learning model/system 127, in accordance with the present principles and as described above.

In accordance with the present principles, once at least one unlabeled class data representation, such as an unlabeled image representation, is labeled, the pretrained machine learning model can be adapted for improved task performance in a domain of the at least one unlabeled target class data for which coverage was improved by retraining the pretrained machine learning model using the labeled at least one unlabeled class data representation. In some embodiments of the present principles, a labeling module of the present principles, such as the labeling module 125 of FIG. 1, can retrain the adapted pretrained machine learning model using the machine learning system 127 of FIG. 1. Alternatively or in addition, in some embodiments, the adapted, pretrained machine learning system can be retrained by a human interacting with the active learning training system 100 of FIG. 1, such as the human that provides labeling.

In some embodiments of the present principles, an embedding space associated with an adapted, pretrained machine learning model, such as the embedding space 200, is reanalyzed to select, for labeling, at least one unlabeled class data representation using the newly labeled class data representation that was previously unlabeled in the embedding space. In some embodiments, the embedding space of the pretrained machine learning model can be reanalyzed by the distance measurement module 120 of the active learning training system 100 of FIG. 1 in accordance with the present principles and as described above with respect to the initial analyzation of the embedding space 200 for determining and selecting at least one unlabeled class data representation for adapting a pretrained machine learning model using active learning for improved task performance in a target domain in accordance with the present principles. For example, in the embodiment of FIG. 1, the labeling module 125 can communicate a pre-trained machine learning model, adapted in accordance with the present principles, via the feedback path 140 to an input of the active learning training system 100.

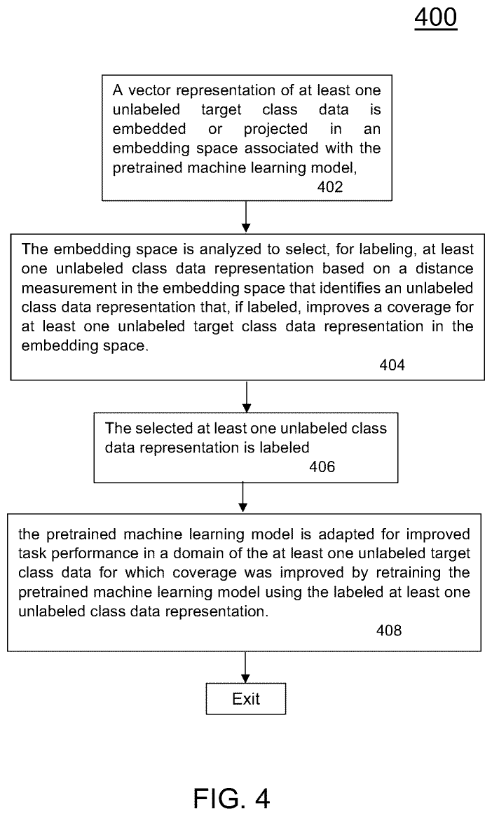

FIG. 4 depicts a flow diagram of a method 400 for adapting a pretrained machine learning model using active learning for improved task performance in a target domain in which the pretrained model was not originally trained. The method 400 of FIG. 4 can begin at 402 during which a vector representation of at least one unlabeled target class data is embedded or projected in an embedding space associated with the pretrained machine learning model, the embeddings space including embedded, respective vector representations of labeled class data and unlabeled class data. The method can proceed to 404.

At 404, the embedding space is analyzed to select, for labeling, at least one unlabeled class data representation based on a distance measurement in the embedding space that identifies an unlabeled class data representation that, if labeled, improves a coverage for at least one unlabeled target class data representation in the embedding space. The method 400 can proceed to 406.

At 406, the selected at least one unlabeled class data representation is labeled. The method 400 can proceed to 408.

At 408, the pretrained machine learning model is adapted for improved task performance in a domain of the at least one unlabeled target class data for which coverage was improved by retraining the pretrained machine learning model using the labeled at least one unlabeled class data representation. The method 400 can be exited.

In some embodiments, the machine learning model comprises an image classifier, the embedded labeled class data and unlabeled class data comprise labeled image representations and unlabeled image representations, and the target class data comprises unlabeled test image representations.

In some embodiments, at least one unlabeled class data representation that maximizes a coverage score in the embedding space for the at least one unlabeled target class data representation is selected for labeling.

In some embodiments the method further includes determining an area of coverage for each labeled class data representation in the embedding space, determining an area in the embedding space having limited coverage by at least one labeled class data representation for at least one of the at least one unlabeled class data representations, and selecting, for labeling, at least one unlabeled class data representation in the area of limited coverage based on a distance measurement in the embedding space that identifies an unlabeled class data representation in the limited coverage area that, if labeled, improves a coverage for at least one unlabeled target class data representation in the embedding space.

In some embodiments, the method further includes reanalyzing the embedding space to select, for labeling, at least one unlabeled class data representation using the newly labeled class data representation that was previously unlabeled in the embedding space.

In some embodiments, the selected at least one unlabeled class data representation is labeled with the assistance of a human. In some embodiments, the selected at least one unlabeled class data representation is labeled using a machine learning model.

In some embodiments, an apparatus for adapting a pretrained machine learning model using active learning for improved task performance in a target domain in which the pretrained model was not originally trained includes a processor and a memory accessible to the processor. In such embodiments, the memory has stored therein at least one of programs or instructions which when executed by the processor configures the apparatus to embed or project a vector representation of at least one unlabeled target class data in an embedding space associated with the pretrained machine learning model, the embeddings space including embedded, respective vector representations of labeled class data and unlabeled class data, analyze the embedding space to select, for labeling, at least one unlabeled class data representation based on a distance measurement in the embedding space that identifies an unlabeled class data representation that, if labeled, improves a coverage for at least one unlabeled target class data representation in the embedding space, label the selected at least one unlabeled class data representation, and adapt the pretrained machine learning model for improved task performance in a domain of the at least one unlabeled target class data for which coverage was improved by retraining the pretrained machine learning model using the labeled at least one unlabeled class data representation.

In some embodiments, the apparatus is further configured to determine an area of coverage for each labeled class data representation in the embedding space, determine an area in the embedding space having limited coverage by at least one labeled class data representation for at least one of the at least one unlabeled class data representations, and select, for labeling, at least one unlabeled class data representation in the area of limited coverage based on a distance measurement in the embedding space that identifies an unlabeled class data representation in the limited coverage area that, if labeled, improves a coverage for at least one unlabeled target class data representation in the embedding space.

In some embodiments, the apparatus is further configured to reanalyze the embedding space to select, for labeling, at least one unlabeled class data representation using the newly labeled class data representation that was previously unlabeled in the embedding space.

In some embodiments, a non-transitory computer readable storage medium has stored thereon instructions that when executed by a processor perform a method for adapting a pretrained machine learning model using active learning for improved task performance in a target domain in which the pretrained model was not originally trained. In some embodiments, the method includes embedding or projecting a vector representation of at least one unlabeled target class data in an embedding space associated with the pretrained machine learning model, the embeddings space including embedded, respective vector representations of labeled class data and unlabeled class data, analyzing the embedding space to select, for labeling, at least one unlabeled class data representation based on a distance measurement in the embedding space that identifies an unlabeled class data representation that, if labeled, improves a coverage for at least one unlabeled target class data representation in the embedding space, labeling the selected at least one unlabeled class data representation, and adapting the pretrained machine learning model for improved task performance in a domain of the at least one unlabeled target class data for which coverage was improved by retraining the pretrained machine learning model using the labeled at least one unlabeled class data representation.

In some embodiments, the method further includes determining an area of coverage for each labeled class data representation in the embedding space, determining an area in the embedding space having limited coverage by at least one labeled class data representation for at least one of the at least one unlabeled class data representations, and selecting, for labeling, at least one unlabeled class data representation in the area of limited coverage based on a distance measurement in the embedding space that identifies an unlabeled class data representation in the limited coverage area that, if labeled, improves a coverage for at least one unlabeled target class data representation in the embedding space.

In some embodiments, the method further includes reanalyzing the embedding space to select, for labeling, at least one unlabeled class data representation using the newly labeled class data representation that was previously unlabeled in the embedding space.

Experiments were conducted using an active learning training system of the present principles, such as the active learning training system 100 of FIG. 1, under the cross-domain few-shot learning setting in which the embeddings of an embedded space were pre-trained on the ImageNet-IK dataset and tested on CIFAH-100, CUB, DomainNet-Real, and DomainNet-Clipart datasets. In the experiment, an up to 4.5% accuracy improvement at 6.2 labels/class or equivalently 2.5× data reduction at 10 labels/class were observed using the distance-goal approach of the present principles versus not using the distance-goal approach.

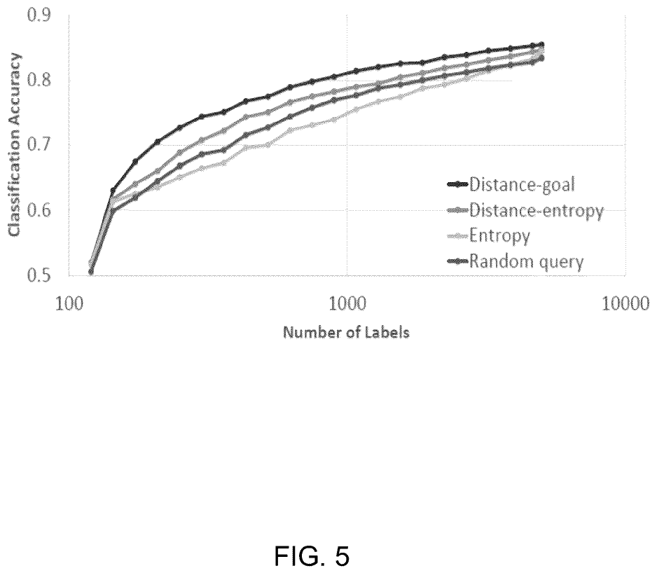

FIG. 5 depicts a table listing classification accuracy on the DomainNet-Heal dataset using different active learning/labeling techniques including random query, entropy-based, and the distance-based techniques of the present principles, distance-entropy and distance-goal. As depicted in FIG. 5, for cases with less than 50 labels/class, the active learning/labeling techniques depicted in FIG. 5, such as the entropy-based technique, other than the distance-measure techniques of the present principles can be unreliable, resulting in inferior classification accuracy. In contrast, the distance-based technique of the present principles improves classification accuracy in such, low-shot regimes with up to a 4.5% accuracy improvement at 6.2 labels/class or equivalently 2.5× data reduction at 10 labels/class.

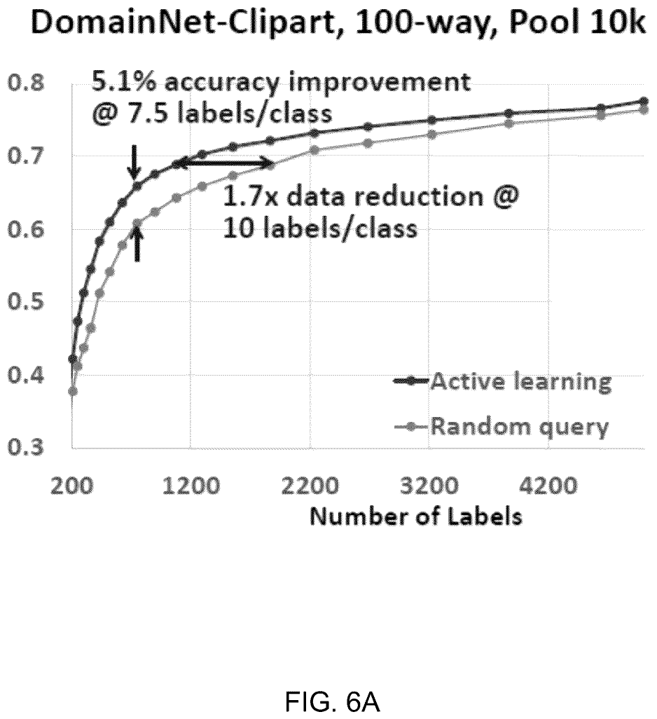

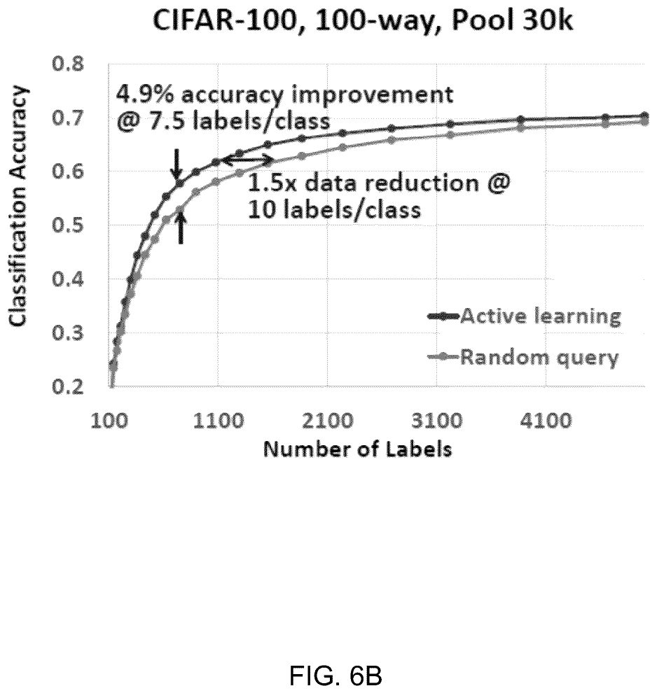

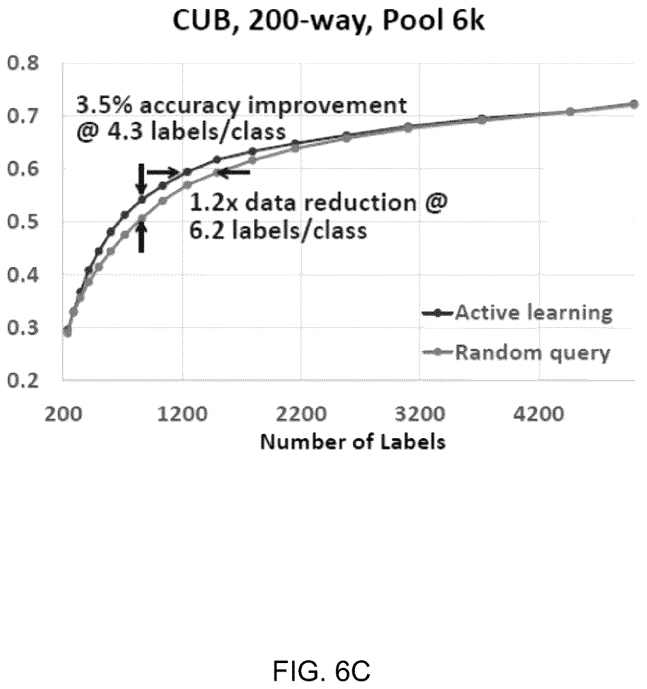

FIGS. 6A, 6B and 6C depict results of an active learning training system of the present principles, such as the active learning training system 100 of FIG. 1, on DomainNet-Clipart, CIFAR-100, and CUB datasets, respectively. As depicted in FIGS. 6A, 6B and 6C, the active learning training system of the present achieved 5.1%, 4.9%, and 3.5% accuracy improvements at 7.5 labels/class, 7.5 labels/class, and 43 labels/class for the DomainNet-Clipart, CIFAR-100, and CUB datasets, respectively.

Embodiments of the present principles can be implemented in any technical applications in which machine learning systems, such as image classification and object detections system can be applied including, but not limited to healthcare industries to, for example, assist in identifying diseases and abnormalities, security industries for, for example, feature detection of humans and objects, data analytics industries to identify documents, autonomous driving vehicles industries to, for example, map environments, and may more.

As depicted in FIG. 1, embodiments of an active learning training system of the present principles, such as the active learning training system 100 of FIG. 1, can be implemented in a computing device 700 in accordance with the present principles. That is, in some embodiments, data can be communicated to, for example, the embedding module 110 of the active learning training system 100 of FIG. 1 using the computing device 700 via, for example, any input/output means associated with the computing device 700. Data associated with an active learning training system in accordance with the present principles can be presented to a user using an output device of the computing device 700, such as a display, a printer or any other form of output device.

For example, FIG. 7 depicts a high-level block diagram of a computing device 700 suitable for use with embodiments of an active learning training system in accordance with the present principles, such as the active learning training system 100 of FIG. 1. In some embodiments, the computing device 700 can be configured to implement methods of the present principles as processor-executable program instructions 722 (e.g., program instructions executable by processor(s) 710) in various embodiments.

In the embodiment of FIG. 7, the computing device 700 includes one or more processors 710a-710n coupled to a system memory 720 via an input/output (I/O) interface 730. The computing device 700 further includes a network interface 740 coupled to I/O interface 730, and one or more input/output devices 750, such as cursor control device 760, keyboard 770, and display(s) 780. In various embodiments, a user interface can be generated and displayed on display 780. In some cases, it is contemplated that embodiments can be implemented using a single instance of computing device 700, while in other embodiments multiple such systems, or multiple nodes making up the computing device 700, can be configured to host different portions or instances of various embodiments. For example, in one embodiment some elements can be implemented via one or more nodes of the computing device 700 that are distinct from those nodes implementing other elements. In another example, multiple nodes may implement the computing device 700 in a distributed manner.

In different embodiments, the computing device 700 can be any of various types of devices, including, but not limited to, a personal computer system, desktop computer, laptop, notebook, tablet or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, the computing device 700 can be a uniprocessor system including one processor 710, or a multiprocessor system including several processors 710 (e.g., two, four, eight, or another suitable number). Processors 710 can be any suitable processor capable of executing instructions. For example, in various embodiments processors 710 may be general-purpose or embedded processors implementing any of a variety of instruction set architectures (ISAs). In multiprocessor systems, each of processors 710 may commonly, but not necessarily, implement the same ISA.

System memory 720 can be configured to store program instructions 722 and/or data 732 accessible by processor 710. In various embodiments, system memory 720 can be implemented using any suitable memory technology, such as static random-access memory (SRAM), synchronous dynamic RAM (SDRAM), nonvolatile/Flash-type memory, or any other type of memory. In the illustrated embodiment, program instructions and data implementing any of the elements of the embodiments described above can be stored within system memory 720. In other embodiments, program instructions and/or data can be received, sent or stored upon different types of computer-accessible media or on similar media separate from system memory 720 or computing device 700.

In one embodiment, I/O interface 730 can be configured to coordinate I/O traffic between processor 710, system memory 720, and any peripheral devices in the device, including network interface 740 or other peripheral interfaces, such as input/output devices 750. In some embodiments, I/O interface 730 can perform any necessary protocol, timing or other data transformations to convert data signals from one component (e.g., system memory 720) into a format suitable for use by another component (e.g., processor 710). In some embodiments, I/O interface 730 can include support for devices attached through various types of peripheral buses, such as a variant of the Peripheral Component Interconnect (PCI) bus standard or the Universal Serial Bus (USB) standard, for example. In some embodiments, the function of I/O interface 730 can be split into two or more separate components, such as a north bridge and a south bridge, for example. Also, in some embodiments some or all of the functionality of I/O interface 730, such as an interface to system memory 720, can be incorporated directly into processor 710.

Network interface 740 can be configured to allow data to be exchanged between the computing device 700 and other devices attached to a network (e.g., network 790), such as one or more external systems or between nodes of the computing device 700. In various embodiments, network 790 can include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 740 can support communication via wired or wireless general data networks, such as any suitable type of Ethernet network, for example; via digital fiber communications networks; via storage area networks such as Fiber Channel SANs, or via any other suitable type of network and/or protocol.

Input/output devices 750 can, in some embodiments, include one or more display terminals, keyboards, keypads, touchpads, scanning devices, voice or optical recognition devices, or any other devices suitable for entering or accessing data by one or more computer systems. Multiple input/output devices 750 can be present in computer system or can be distributed on various nodes of the computing device 700. In some embodiments, similar input/output devices can be separate from the computing device 700 and can interact with one or more nodes of the computing device 700 through a wired or wireless connection, such as over network interface 740.

Those skilled in the art will appreciate that the computing device 700 is merely illustrative and is not intended to limit the scope of embodiments. In particular, the computer system and devices can include any combination of hardware or software that can perform the indicated functions of various embodiments, including computers, network devices, Internet appliances, PDAs, wireless phones, pagers, and the like. The computing device 700 can also be connected to other devices that are not illustrated, or instead can operate as a stand-alone system. In addition, the functionality provided by the illustrated components can in some embodiments be combined in fewer components or distributed in additional components. Similarly, in some embodiments, the functionality of some of the illustrated components may not be provided and/or other additional functionality can be available.

The computing device 700 can communicate with other computing devices based on various computer communication protocols such a Wi-Fi, Bluetooth®. (and/or other standards for exchanging data over short distances includes protocols using short-wavelength radio transmissions), USB, Ethernet, cellular, an ultrasonic local area communication protocol, etc. The computing device 700 can further include a web browser.

Although the computing device 700 is depicted as a general-purpose computer, the computing device 700 is programmed to perform various specialized control functions and is configured to act as a specialized, specific computer in accordance with the present principles, and embodiments can be implemented in hardware, for example, as an application specified integrated circuit (ASIC). As such, the process steps described herein are intended to be broadly interpreted as being equivalently performed by software, hardware, or a combination thereof.

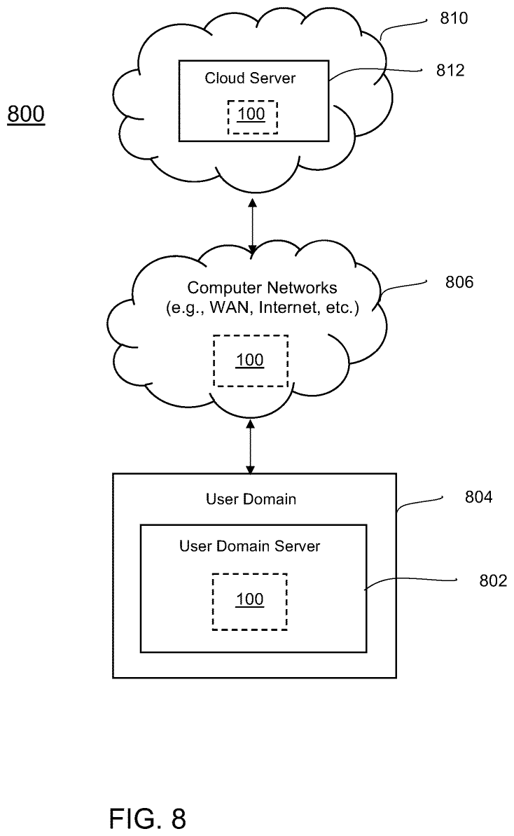

FIG. 8 depicts a high-level block diagram of a network in which embodiments of an active learning training system in accordance with the present principles, such as the active learning training system 100 of FIG. 1, can be applied. The network environment 800 of FIG. 8 illustratively comprises a user domain 802 including a user domain server/computing device 804. The network environment 800 of FIG. 8 further comprises computer networks 806, and a cloud environment 810 including a cloud server/computing device 812.

In the network environment 800 of FIG. 8, a system for adapting a pretrained machine learning model for active learning for, for example, few-shot learning in accordance with the present principles, such as the active learning training system 100 of FIG. 1, can be included in at least one of the user domain server/computing device 804, the computer networks 806, and the cloud server/computing device 812. That is, in some embodiments, a user can use a local server/computing device (e.g., the user domain server/computing device 804) to provide data (e.g., embedding space data, etc.) for an active learning training system of the present principles to adapt a pretrained machine learning model for active learning for, for example, few-shot learning in accordance with the present principles.

In some embodiments, a user can implement an active learning training system of the present principles in the computer networks 806 to adapt a pretrained machine learning model for active learning for, for example, few-shot learning in accordance with the present principles. Alternatively or in addition, in some embodiments, a user can implement an active learning training system of the present principles in the cloud server/computing device 812 of the cloud environment 810 in accordance with the present principles. For example, in some embodiments it can be advantageous to perform processing functions of the present principles in the cloud environment 810 to take advantage of the processing capabilities and storage capabilities of the cloud environment 810. In some embodiments in accordance with the present principles, a system for adapting a pretrained machine learning model for active learning for, for example, few-shot learning can be located in a single and/or multiple locations/servers/computers to perform all or portions of the herein described functionalities of a system in accordance with the present principles. For example, in some embodiments components of an active learning training system of the present principles, such as the embedding module 110, the distance measurement module 120, and the labeling module 125 of the active learning training system 100 of FIG. 1, can be located in one or more than one of the user domain 802, the computer network environment 806, and the cloud environment 810 for providing the functions described above either locally and/or remotely and/or in a distributed manner.

Those skilled in the art will also appreciate that, while various items are illustrated as being stored in memory or on storage while being used, these items or portions of them can be transferred between memory and other storage devices for purposes of memory management and data integrity. Alternatively, in other embodiments some or all of the software components can execute in memory on another device and communicate with the illustrated computer system via inter-computer communication. Some or all of the system components or data structures can also be stored (e.g., as instructions or structured data) on a computer-accessible medium or a portable article to be read by an appropriate drive, various examples of which are described above. In some embodiments, instructions stored on a computer-accessible medium separate from the computing device 700 can be transmitted to the computing device 700 via transmission media or signals such as electrical, electromagnetic, or digital signals, conveyed via a communication medium such as a network and/or a wireless link. Various embodiments can further include receiving, sending or storing instructions and/or data implemented in accordance with the foregoing description upon a computer-accessible medium or via a communication medium. In general, a computer-accessible medium can include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods and processes described herein may be implemented in software, hardware, or a combination thereof, in different embodiments. In addition, the order of methods can be changed, and various elements can be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing device or a “virtual machine” running on one or more computing devices). For example, a machine-readable medium can include any suitable form of volatile or non-volatile memory.

In addition, the various operations, processes, and methods disclosed herein can be embodied in a machine-readable medium and/or a machine accessible medium/storage device compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium/storage device.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected.

1. A method for adapting a pretrained machine learning model using active learning for improved task performance in a target domain in which the pretrained model was not originally trained, comprising:
embedding or projecting a vector representation of at least one unlabeled target class data in an embedding space associated with the pretrained machine learning model, the embeddings space including embedded, respective vector representations of labeled class data and unlabeled class data;
analyzing the embedding space to select, for labeling, at least one unlabeled class data representation based on a distance measurement in the embedding space that identifies an unlabeled class data representation that, if labeled, improves a coverage for at least one unlabeled target class data representation in the embedding space;
labeling the selected at least one unlabeled class data representation; and
adapting the pretrained machine learning model for improved task performance in a domain of the at least one unlabeled target class data for which coverage was improved by retraining the pretrained machine learning model using the labeled at least one unlabeled class data representation.

2. The method of claim 1, wherein the machine learning model comprises an image classifier, the embedded labeled class data and unlabeled class data comprise labeled image representations and unlabeled image representations, and the target class data comprises unlabeled test image representations.

3. The method of claim 1, wherein at least one unlabeled class data representation that maximizes a coverage score in the embedding space for the at least one unlabeled target class data representation is selected for labeling.

4. The method of claim 1, further comprising:
determining an area of coverage for each labeled class data representation in the embedding space;
determining an area in the embedding space having limited coverage by at least one labeled class data representation for at least one of the at least one unlabeled class data representations; and
selecting, for labeling, at least one unlabeled class data representation in the area of limited coverage based on a distance measurement in the embedding space that identifies an unlabeled class data representation in the limited coverage area that, if labeled, improves a coverage for at least one unlabeled target class data representation in the embedding space.

5. The method of claim 1, further comprising:
reanalyzing the embedding space to select, for labeling, at least one unlabeled class data representation using the newly labeled class data representation that was previously unlabeled in the embedding space.

6. The method of claim 1, wherein the selected at least one unlabeled class data representation is labeled with the assistance of a human.

7. The method of claim 1, wherein the selected at least one unlabeled class data representation is labeled using a machine learning model.

8. An apparatus for adapting a pretrained machine learning model using active learning for improved task performance in a target domain in which the pretrained model was not originally trained, comprising:
a processor; and
a memory accessible to the processor, the memory having stored therein at least one of programs or instructions executable by the processor to configure the apparatus to:
embed or project a vector representation of at least one unlabeled target class data in an embedding space associated with the pretrained machine learning model, the embeddings space including embedded, respective vector representations of labeled class data and unlabeled class data;
analyze the embedding space to select, for labeling, at least one unlabeled class data representation based on a distance measurement in the embedding space that identifies an unlabeled class data representation that, if labeled, improves a coverage for at least one unlabeled target class data representation in the embedding space;
label the selected at least one unlabeled class data representation; and
adapt the pretrained machine learning model for improved task performance in a domain of the at least one unlabeled target class data for which coverage was improved by retraining the pretrained machine learning model using the labeled at least one unlabeled class data representation.

9. The apparatus of claim 8, wherein the machine learning model comprises an image classifier, the embedded labeled class data and unlabeled class data comprise labeled image representations and unlabeled image representations, and the target class data comprises unlabeled test image representations.

10. The apparatus of claim 8, wherein at least one unlabeled class data representation that maximizes a coverage score in the embedding space for the at least one unlabeled target class data representation is selected for labeling.

11. The apparatus of claim 8, wherein the apparatus is further configured to:
determine an area of coverage for each labeled class data representation in the embedding space;
determine an area in the embedding space having limited coverage by at least one labeled class data representation for at least one of the at least one unlabeled class data representations; and
select, for labeling, at least one unlabeled class data representation in the area of limited coverage based on a distance measurement in the embedding space that identifies an unlabeled class data representation in the limited coverage area that, if labeled, improves a coverage for at least one unlabeled target class data representation in the embedding space.

12. The apparatus of claim 8, wherein the apparatus is further configured to:
reanalyze the embedding space to select, for labeling, at least one unlabeled class data representation using the newly labeled class data representation that was previously unlabeled in the embedding space.

13. The apparatus of claim 8, wherein the selected at least one unlabeled class data representation is labeled with the assistance of a human.

14. The apparatus of claim 8, wherein the selected at least one unlabeled class data representation is labeled using a machine learning model.

15. A non-transitory computer readable storage medium having stored thereon instructions that when executed by a processor perform a method for adapting a pretrained machine learning model using active learning for improved task performance in a target domain in which the pretrained model was not originally trained, comprising:
embedding or projecting a vector representation of at least one unlabeled target class data in an embedding space associated with the pretrained machine learning model, the embeddings space including embedded, respective vector representations of labeled class data and unlabeled class data;
analyzing the embedding space to select, for labeling, at least one unlabeled class data representation based on a distance measurement in the embedding space that identifies an unlabeled class data representation that, if labeled, improves a coverage for at least one unlabeled target class data representation in the embedding space;
labeling the selected at least one unlabeled class data representation; and
adapting the pretrained machine learning model for improved task performance in a domain of the at least one unlabeled target class data for which coverage was improved by retraining the pretrained machine learning model using the labeled at least one unlabeled class data representation.

16. The non-transitory computer readable storage medium of claim 15, wherein the machine learning model comprises an image classifier, the embedded labeled class data and unlabeled class data comprise labeled image representations and unlabeled image representations, and the target class data comprises unlabeled test image representations.

17. The non-transitory computer readable storage medium of claim 15, wherein at least one unlabeled class data representation that maximizes a coverage score in the embedding space for the at least one unlabeled target class data representation is selected for labeling.

18. The non-transitory computer readable storage medium of claim 15, wherein the method further comprises:
determining an area of coverage for each labeled class data representation in the embedding space;
determining an area in the embedding space having limited coverage by at least one labeled class data representation for at least one of the at least one unlabeled class data representations; and
selecting, for labeling, at least one unlabeled class data representation in the area of limited coverage based on a distance measurement in the embedding space that identifies an unlabeled class data representation in the limited coverage area that, if labeled, improves a coverage for at least one unlabeled target class data representation in the embedding space.

19. The non-transitory computer readable storage medium of claim 15, wherein the method further comprises:
reanalyzing the embedding space to select, for labeling, at least one unlabeled class data representation using the newly labeled class data representation that was previously unlabeled in the embedding space.

20. The non-transitory computer readable storage medium of claim 15, wherein the selected at least one unlabeled class data representation is labeled with at least one of a machine learning model or the assistance of a human.
